(19) United States
(12) Patent Application Publication
(10) Pub. No.: US 2015/0056395 A1
(43) Pub. Date: Feb. 26, 2015

(54) SCREEN PROTECTOR DEVICE WITH AUXILIARY STRIP

(71) Applicant: Uniproo Inc., Taoyuan County (TW)

(72) Inventor: Cheng-Huang LIN, Taoyuan County (TW)

(73) Assignee: Uniproo Inc., Taoyuan County (TW)

(21) Appl. No.: 13/973,313

(22) Filed: Aug. 22, 2013

(51) Int. Cl. B32B 7/06

(52) U.S. Cl. CPC B32B 7/06
USPC 428/41.7; 428/77; 428/78

(57) ABSTRACT

A screen protector device includes a transparent sheet, a first protective film, and an auxiliary strip. The transparent sheet comprises an inner surface, an outer surface, and a first edge. The first protective film comprises a first surface and a second surface, wherein the first surface is detachably attached to the inner surface. The auxiliary strip is positioned on the second surface of the first protective film, within a boundary of the transparent sheet, and has hardness greater than hardness of the first protective film. The auxiliary strip and the first edge are of a same side of the screen protector device, and a gap between the auxiliary strip and the first edge is less than a predetermined value.

### BACKGROUND

The disclosure generally relates to a screen protector device and, more particularly, to the screen protector device having auxiliary strip so that the screen protector device could be more successfully attached to a screen.

In order to prevent a screen from being scratched or smudged, many people choose to paste a screen protector on a surface of the screen to protect the screen. However, since the screen protector and a protective film attached to the screen protector is typically soft and flexible, the protective film is prone to deformation due to the force exerted on the screen protector by a user, thereby resulting in deformation of the screen protector and strip bulges between the screen protector and the screen. As a result, the screen protector is not smoothly attached to the screen, and the user has to remove and reinstall the screen protector in order to render the screen protector smoothly attached to the screen. Reinstallation is not only time-consuming, but also reduces adhesion of the screen protector, thereby increasing the possibility of the screen protector peeling off the screen. Additionally, reinstallation may increase the possibility that particles or dusts get trapped on the screen protector, and result in air bubbles between the screen protector and the screen.

On the other hand, since the screen protector is difficult to be accurately aligned with the screen in all directions, especially when the screen size is larger, the user may find the screen protector deviated from the screen when attaching the screen protector onto the screen. In this situation, the user has to remove and reinstall the screen protector in order to render the screen protector accurately attached to the screen, thereby causing the aforementioned problems.

### SUMMARY

An example embodiment of a screen protector device is disclosed, comprising: a transparent sheet, comprising an inner surface, an outer surface, and a first edge; a first protective film, comprising a first surface and a second surface; and an auxiliary strip, positioned on the second surface of the first protective film, having hardness greater than hardness of the first protective film; wherein the first surface is detachably attached to the inner surface; wherein the auxiliary strip is positioned within a boundary of the transparent sheet, the auxiliary strip and the first edge are of a same side of the screen protector device, and a gap between the auxiliary strip and the first edge is less than a predetermined value.

Another example embodiment of a screen protector device is disclosed, comprising: a transparent sheet, comprising an inner surface, an outer surface, a first edge, and a second edge perpendicular to the first edge; a first protective film, comprising a first surface and a second surface; a second protective film, comprising a third surface detachably attached to the outer surface; an auxiliary strip, positioned on the second surface of the first protective film, having a hardness greater than a hardness of the first protective film; and multiple positioning parts, each of which attached to the second protective film, and each of the multiple positioning parts comprising a protruding part outside the boundary of the transparent sheet, an adhesive area attached to the protruding part, and a strippable sheet detachably attached to the adhesive area; wherein the first surface is detachably attached to the inner surface; wherein the auxiliary strip is positioned within the boundary of the transparent sheet, and a gap between the auxiliary strip and the first edge is less than 1 cm; wherein the auxiliary strip has a length larger than four fifths of a length of the first edge, and has a width larger than 0.5 cm and smaller than one fifteenth of a length of the second edge; wherein a total length of the multiple positioning parts is larger than two thirds of the length of the first edge; wherein the multiple positioning parts, the auxiliary strip, and the first edge are of a same side of the screen protector device.

Both the foregoing general description and the following detailed description are examples and explanatory only, and are not restrictive of the invention as claimed.

### BRIEF DESCRIPTION OF THE DRAWINGS

FIG. 1 shows a simplified schematic diagram of back view of a screen protector device according to one embodiment of the present disclosure.

FIG. 2 shows a simplified schematic diagram of front view of the screen protector device of FIG. 1 according to one embodiment of the present disclosure.

FIG. 3 shows a simplified schematic diagram of an operation for attaching the screen protector device of FIG. 1 onto a screen according to one embodiment of the present disclosure.

FIG. 4 shows a simplified schematic diagram of back view of a screen protector device according to another embodiment of the present disclosure.

FIG. 5 shows a simplified schematic diagram of back view of a screen protector device according to another embodiment of the present disclosure.

FIG. 6 shows a simplified schematic diagram of front view of a screen protector device according to another embodiment of the present disclosure.

FIG. 7 shows a simplified schematic diagram of back view of the screen protector device of FIG. 6 according to another embodiment of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

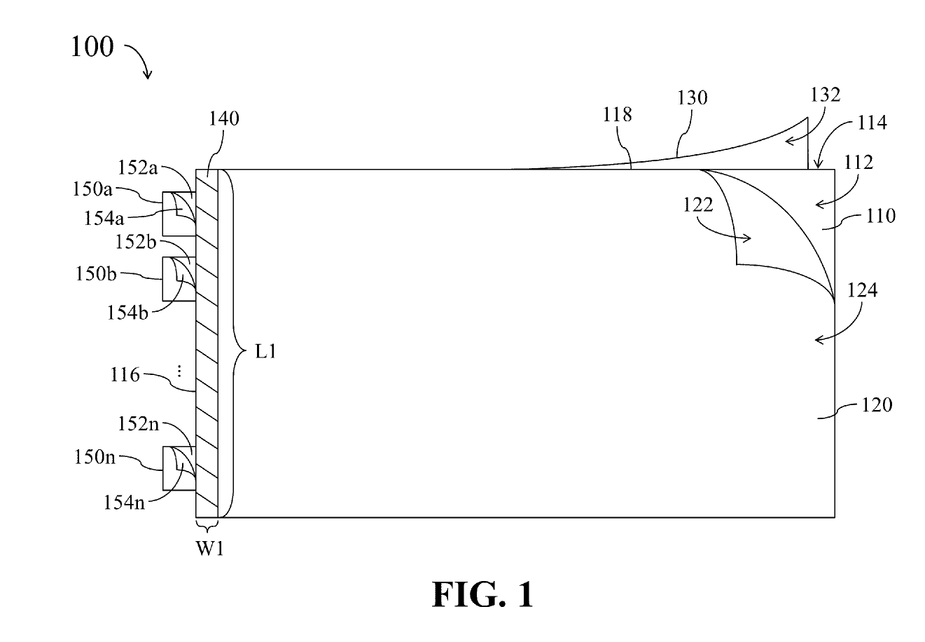

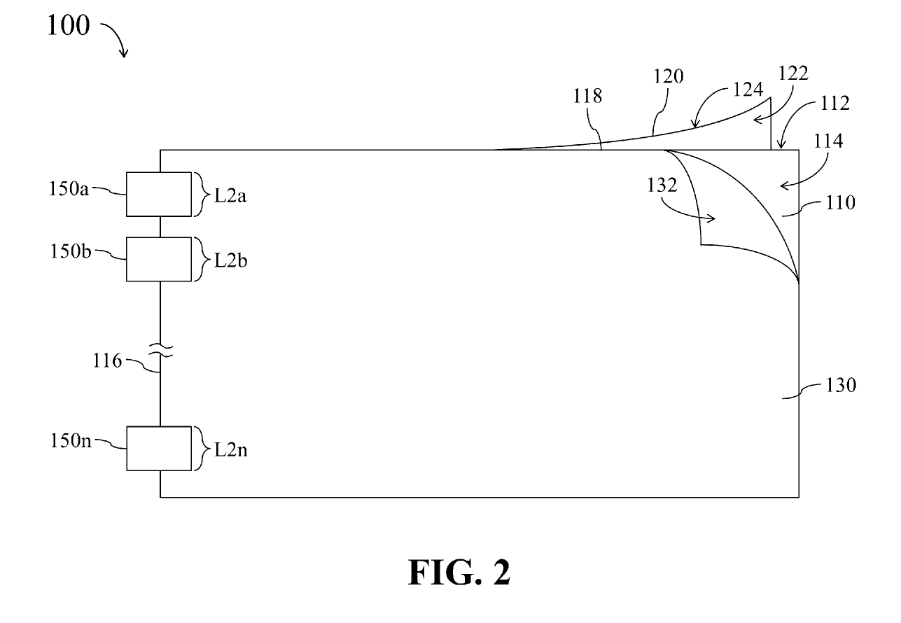

Please refer to FIGS. 1 and 2. FIG. 1 shows a simplified schematic diagram of back view of a screen protector device 100 according to one embodiment of the present disclosure. FIG. 2 shows a simplified schematic diagram of front view of the screen protector device 100 according to one embodiment of the present disclosure. In the embodiment of FIG. 1, the screen protector device 100 comprises a transparent sheet 110, a first protective film 120, a second protective film 130, an auxiliary strip 140, and multiple positioning parts 150a˜150n.

The transparent sheet 110 comprises an inner surface 112, an outer surface 114, a first edge 116, and a second edge 118. The first edge 116 is perpendicular to the second edge 118. The transparent sheet 110 has a shape dimensioned corresponding to a screen of an electronic device such as a television or a tablet computer. In practice, the transparent sheet 110 may be a screen protector film or a privacy screen film, and may be realized with a tempered glass sheet or a plastic sheet.

The first protective film 120 comprises a first surface 122 and a second surface 124. The first surface 122 is detachably attached to the inner surface 112 to protect the inner surface 112 from being smudged or scratched before the transparent sheet 110 is attached to the screen.

The second protective film 130 comprises a third surface 132. The third surface 132 is detachably attached to the outer surface 114 to protect the outer surface 114 from being smudged or scratched before the transparent sheet 110 is attached to the screen.

In practice, the first protective film 120 and the second protective film 130 may be respectively realized with one or more release films.

The auxiliary strip 140 is positioned on the second surface 124 of the first protective film 120, and has hardness greater than hardness of the first protective film 120. In practice, the auxiliary strip 140 may be realized with one or more strips made by papers, plastic, glass, metal, wood, or other materials.

Each of the multiple positioning parts 150a˜150n is attached to the second protective film 130, and comprises a protruding part outside the boundary of the transparent sheet 110, an adhesive area 152, and a strippable sheet 154. Therefore, the multiple positioning parts 150a˜150n comprise multiple protruding parts, multiple adhesive areas 152a˜152n, and multiple strippable sheets 154a˜154n. The multiple adhesive areas 152a˜152n are respectively attached to the multiple protruding parts. The multiple strippable sheets 154a˜154n are detachably attached to the multiple adhesive areas 152a˜152n, respectively.

As shown in FIG. 1, the auxiliary strip 140, the multiple positioning parts 150a˜150n, and the first edge 116 of the transparent sheet 110 are of the same side of the screen protector device 100.

As shown in FIG. 2, the multiple positioning parts 150a˜150n respectively have lengths L2a˜L2n. The lengths L2a˜L2n may be the same or may be different from each other.

In practice, each of the multiple positioning parts 150a˜150n may be realized with one or more twin adhesive tapes, or other materials with attachment capability, and each of the multiple strippable sheets 154a˜154n may be realized with one or more release films.

Throughout the specification and drawings, indexes a˜n may be used in the reference numbers of components and devices for ease of referring to respective components and devices. The use of indexes a˜n does not intend to restrict the amount of components and devices to any specific number. In the specification and drawings, if a reference number of a particular component or device is used without having the index, it means that the reference number is used to refer to any unspecific component or device of corresponding component group or device group. For example, the reference number 150a is used to refer to the specific positioning part 150a, and the reference number 150 is used to refer to any unspecific positioning part of the multiple positioning parts 150a˜150n.

In the screen protector device 100, the auxiliary strip 140, the multiple positioning parts 150a˜150n, and the first edge 116 are of a same side of the screen protector device 100.

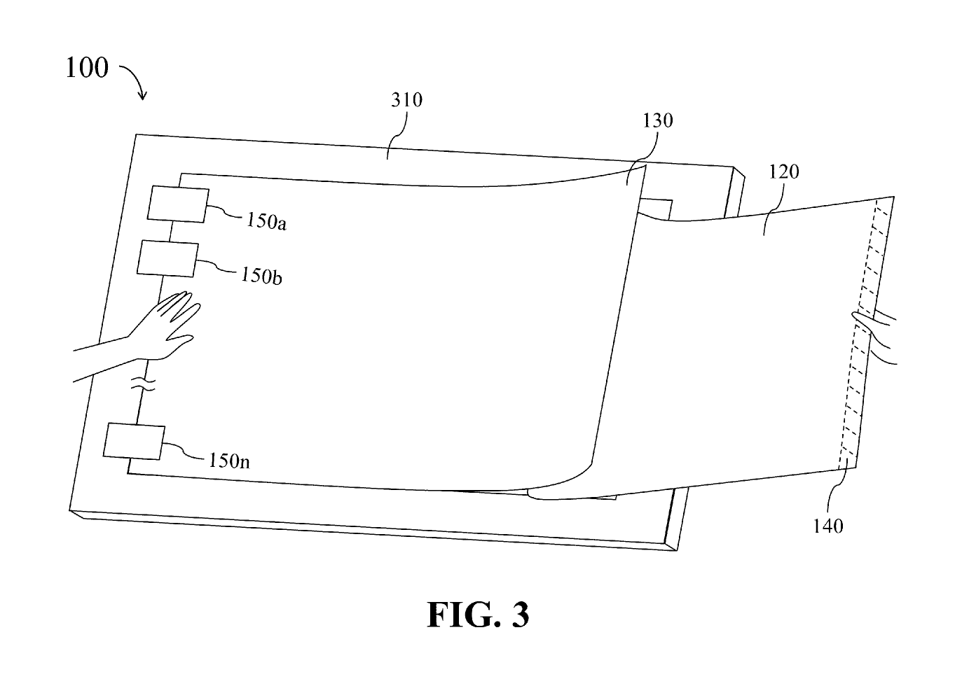

The installation of the screen protector device 100 will be further described in the following by reference to FIG. 3.

FIG. 3 shows a simplified schematic diagram of an operation for attaching the screen protector device 100 onto the screen to be protected according to one embodiment of the present disclosure.

When attaching the screen protector device 100 onto a screen to be protected, the transparent sheet 110 is properly aligned with top of the screen in all directions by the user firstly. Then, the user may peel off the multiple strippable sheets 154a˜154n from the multiple adhesive areas 152a˜152n while pressing the screen protector device 100 onto the screen. The user may respectively attach the multiple adhesive areas 152a˜152n to a peripheral region of the screen, so that a relative position between the screen protector device 100 and the screen does not change in the following stages.

Afterward, the user holds the auxiliary strip 140 to peel off the first protective film 120 from the inner surface 112 of the transparent sheet 110 gently, and gradually attaches the inner surface 112 of the transparent sheet 110 onto the screen. Since the auxiliary strip 140 positioned on the first protective film 120 has sufficient hardness, the force exerted on the auxiliary strip 140 by the user would be evenly spread onto the first protective film 120 through the auxiliary strip 140. Accordingly, the first protective film 120 is not deformed while being peeling off from the inner surface 112, so that deformation of the transparent sheet 110, and strip bulges between the transparent sheet 110 and the screen could be effectively avoided. With the use of the auxiliary strip 140, the transparent sheet 110 could be rapidly and smoothly attached onto the screen, and thus the user needs not remove and reinstall the transparent sheet 110.

After the inner surface 112 of the transparent sheet 110 is attached onto the screen, the second protective film 130 is peeled off gently by the user.

As it can be appreciated from the foregoing description, the transparent sheet 110 could be accurately aligned with the screen in all directions while the transparent sheet 110 is being attached onto the screen through the use of the multiple positioning parts 150a˜150n. Accordingly, the user needs not remove and reinstall the transparent sheet 110.

In the case where the screen size is larger than 20 inches (e.g., the screen size is 24, 40, 50, 60, or 70 inches), the transparent sheet 110 may be more difficult to be properly aligned with the screen in all directions without the multiple positioning parts 150a˜150n. Additionally, while the first protective film 120 is being peeling off from the inner surface 112, the first protective film 120 may be easier to deform without the auxiliary strip 140 since the force exerted on the first protective film 120 by the user is more difficult to be evenly spread onto the first protective film 120. Accordingly, the use of the multiple positioning parts 150a˜150n and the auxiliary strip 140 is very helpful and useful for smoothly and accurately attaching the transparent sheet 110 onto the screen with larger size.

In one embodiment, a length of the first edge 116 may be smaller than the length of the second edge 118. In this situation, when the screen size is larger than 20 inches (e.g., the screen size is 24, 40, 50, 60, or 70 inches), it may be more convenient to apply the transparent sheet 110 to the screen.

The force exerted on the auxiliary strip 140 could be more effectively and evenly spread onto the first protective film 120 if the auxiliary strip 140 has a sufficient length L1 and/or a sufficient width W1. In one embodiment, the length L1 of the auxiliary strip 140 is larger than one third of the length of the first edge 116. In another embodiment, the length L1 of the auxiliary strip 140 is larger than a half of the length of the first edge 116. In another embodiment, the length L1 of the auxiliary strip 140 is larger than four fifths of the length of the first edge 116. In another embodiment, the length L1 of the auxiliary strip 140 is larger than nine tenths of the length of the first edge 116.

In one embodiment, the width W1 of the auxiliary strip 140 is larger than 0.5 cm and smaller than one fifth of a length of the second edge 118. In another embodiment, the width W1 of the auxiliary strip 140 is larger than 0.5 cm and smaller than one tenth of the length of the second edge 118. In another embodiment, the width W1 of the auxiliary strip 140 is larger than 0.5 cm and smaller than one fifteenth of the length of the second edge 118.

The relative position between the transparent sheet 110 and the screen could be more effectively secured while the transparent sheet 110 is being attached to the screen if the multiple positioning parts 150a˜150n has a sufficient total length (=L2a+L2b+ . . . +L2n). In one embodiment, the total length of the multiple positioning parts 150a˜150n is larger than two thirds of the length of the first edge 116.

Additionally, in comparison with the case where only a single positioning part is employed in the screen protector device 100, the use of the multiple positioning parts 150a˜150n, each of which having the length shorter than the length of the single positioning part, enables the user to more smoothly and conveniently attach the multiple adhesive areas 152a˜152n onto the screen without bulges between the peripheral region of the screen and the multiple positioning parts 150a˜150n. In this situation, the transparent sheet 110 could be more accurately aligned with the screen while the transparent sheet 110 is being attached to the screen.

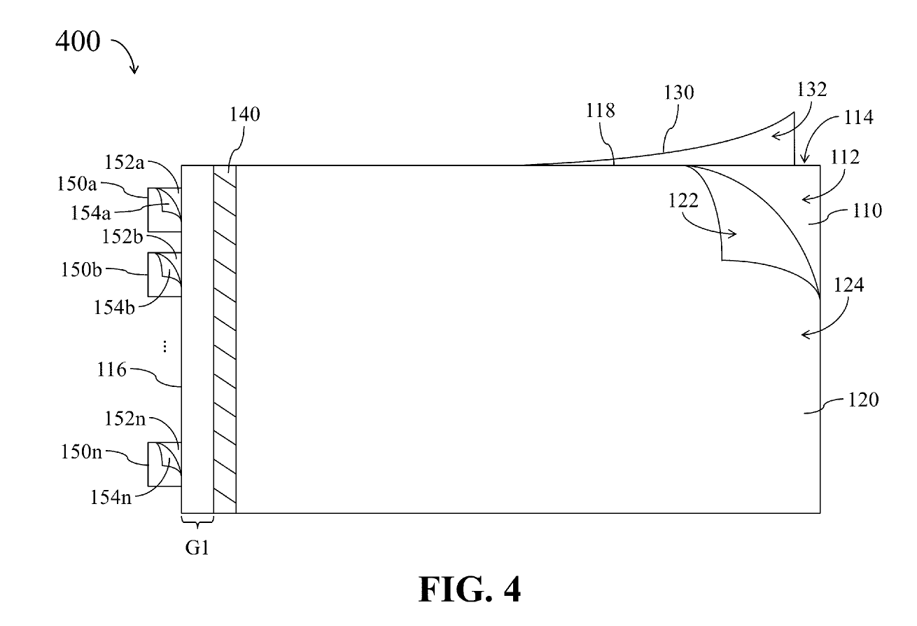

Please refer to FIG. 4, which shows a simplified schematic diagram of back view of a screen protector device 400 according to another embodiment of the present disclosure. The screen protector device 400 is very similar to the screen protector device 100. One of the differences between the two embodiments is that a gap G1 is between the first edge 116 and an auxiliary strip 140 in the screen protector device 400. Such arrangement provides a higher position error tolerance when the auxiliary strip 140 is attached to the first protective film 120, thereby increasing the manufacturing speed and yield rate of the screen protector device. In one embodiment, the gap G1 is less than 1 cm.

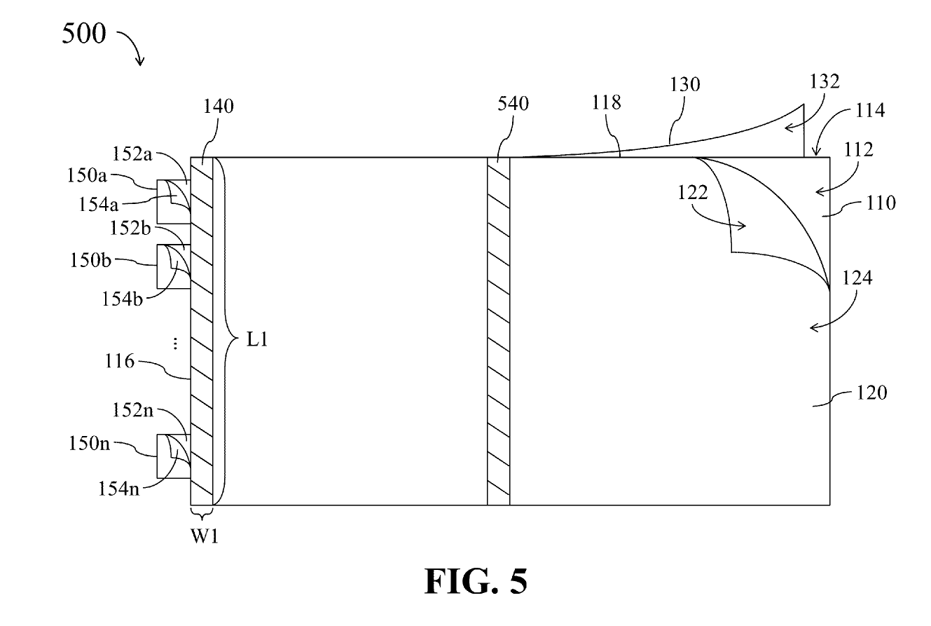

FIG. 5 shows a simplified schematic diagram of back view of a screen protector device 500 according to another embodiment of the present disclosure. The screen protector device 500 is very similar to the screen protector device 100. One of the differences between the two embodiments is that the screen protector device 500 has multiple auxiliary strips, such as the auxiliary strip 140 and an auxiliary strip 540. The auxiliary strip 540 is positioned on about the middle of the first protective film 120, so that the force exerted on the auxiliary strip 140 may be more evenly spread onto the first protective film 120 through the auxiliary strip 540. In some embodiments, the screen protector device may have three or more auxiliary strips.

The descriptions regarding the implementations, the operations, and the related advantages of the screen protector device 100 in the aforementioned embodiment are also applicable to the screen protector device 400 and the screen protector device 500. For simplicity, the descriptions will not be repeated here.

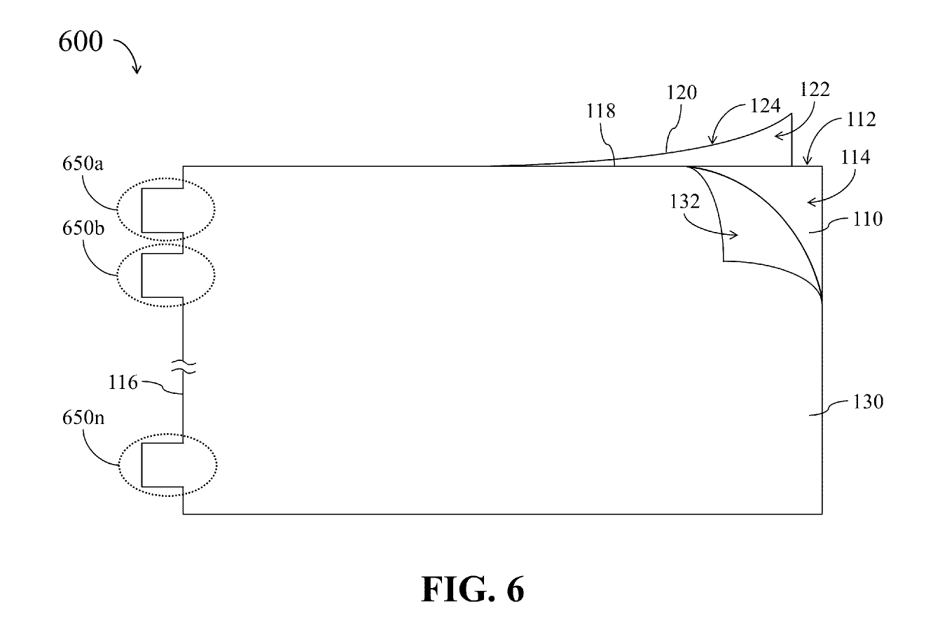

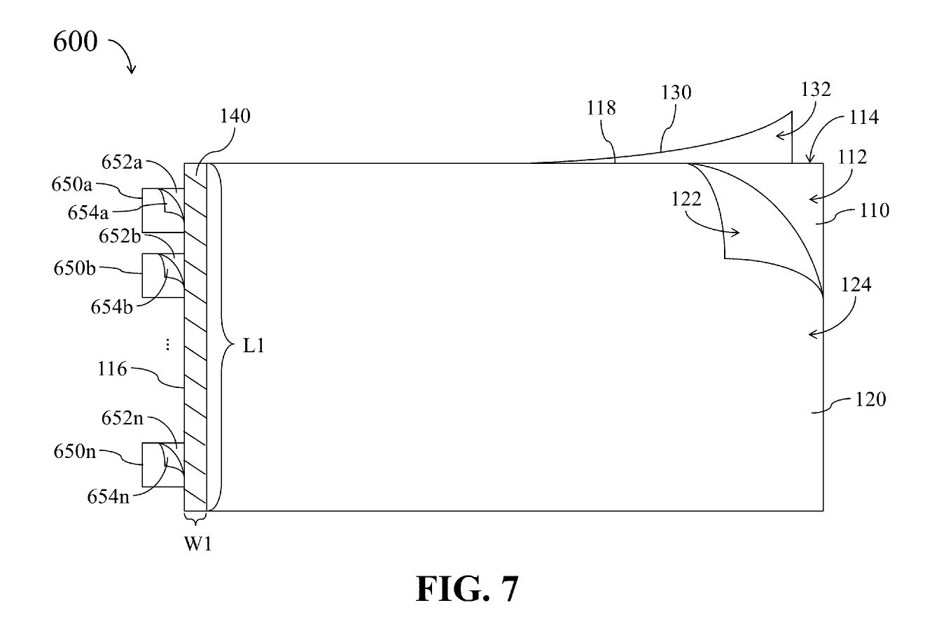

Please refer to FIGS. 6 and 7. FIG. 6 shows a simplified schematic diagram of front view of a screen protector device 600 according to another embodiment of the present disclosure. FIG. 7 shows a simplified schematic diagram of back view of the screen protector device 600 according to another embodiment of the present disclosure. The screen protector device 600 is very similar to the screen protector device 100, one of the differences is that the multiple positioning parts 150a˜150n in the screen protector device 100 are replaced by multiple positioning parts 650a˜650n in the screen protector device 600.

In FIGS. 6 and 7, the third surface 132 comprises multiple extended areas outside the boundary of the transparent sheet 110. Each of the multiple positioning parts 650a˜650n comprises an adhesive area 652 and a strippable sheet 654. Therefore, the multiple positioning parts 650a˜650n comprise multiple adhesive areas 652a˜652n and multiple strippable sheets 654a˜654n. The multiple adhesive areas 652a˜652n are respectively attached to the multiple extended areas of the third surface 132. The multiple strippable sheets 654a˜654n are detachably attached to the multiple adhesive areas 652a˜652n, respectively. In practice, the multiple adhesive areas 652a˜652n may be realized with glue, or other materials with attachment capability. Such arrangement could reduce the costs and complexity of assembling the screen protector device, thereby increasing the manufacturing speed and yield rate of the screen protector device.

The descriptions regarding the implementations, the operations, and the related advantages of the screen protector device 100 in the aforementioned embodiment are also applicable to the screen protector device 600. For simplicity, the descriptions will not be repeated here.

In some embodiments, the multiple positioning parts 150a˜150n in the screen protector devices 400 and 500 may be replaced by the aforementioned multiple positioning parts 650a˜650n to reduce the costs and complexity of assembling the screen protector device.

In some embodiments, the aforementioned screen protector devices 100, 400, 500, and 600 may comprise only one positioning part 150 or 650. Such arrangement may reduce complexity of manufacturing processes of the screen protector device, thereby increasing the manufacturing speed and yield rate of the screen protector device.

In the drawings, the size and relative sizes of some elements may be exaggerated or simplified for clarity. Accordingly, unless the context clearly specifies, the shape, size, relative size, and relative position of each element in the drawings are illustrated merely for clarity, and not intended to be used to restrict the claim scope.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled with,” “couples with,” and “coupling with” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A screen protector device, comprising:
a transparent sheet, comprising an inner surface, an outer surface, and a first edge;
a first protective film, comprising a first surface and a second surface; and
an auxiliary strip, positioned on the second surface of the first protective film, having hardness greater than hardness of the first protective film;
wherein the first surface is detachably attached to the inner surface;
wherein the auxiliary strip is positioned within a boundary of the transparent sheet, the auxiliary strip and the first edge are of a same side of the screen protector device, and a gap between the auxiliary strip and the first edge is less than a predetermined value.

2. The screen protector device of claim 1, wherein a length of the auxiliary strip is larger than one third of a length of the first edge.

3. The screen protector device of claim 1, wherein a length of the auxiliary strip is larger than four fifths of a length of the first edge.

4. The screen protector device of claim 1, wherein the auxiliary strip has a width larger than 0.5 cm and smaller than one fifth of a length of a second edge of the transparent sheet;
wherein the first edge is perpendicular to the second edge.

5. The screen protector device of claim 1, wherein the auxiliary strip has a width larger than 0.5 cm and smaller than one fifteenth of a length of a second edge of the transparent sheet;
wherein the first edge is perpendicular to the second edge.

6. The screen protector device of claim 1, wherein the predetermined value is less than 1 cm.

7. The screen protector device of claim 1, wherein a length of the first edge is smaller than a length of one of edges of the transparent sheet.

8. The screen protector device of claim 1, further comprising:
a second protective film, comprising a third surface detachably attached to the outer surface; and
a positioning part, attached to the second protective film, and the positioning part comprising a protruding part outside the boundary of the transparent sheet, an adhesive area attached to the protruding part, and a strippable sheet detachably attached to the adhesive area;
wherein the positioning part, the auxiliary strip, and the first edge are of the same side of the screen protector device.

9. The screen protector device of claim 8, wherein the positioning part has a length larger than two thirds of a length of the first edge.

10. The screen protector device of claim 1, further comprising:
a second protective film, comprising a third surface detachably attached to the outer surface, the third surface comprising an extended area outside the boundary of the transparent sheet; and
a positioning part, comprising an adhesive area attached to the extended area, and a strippable sheet detachably attached to the adhesive area;
wherein the positioning part, the auxiliary strip, and the first edge are of the same side of the screen protector device.

11. The screen protector device of claim 10, wherein the positioning part has a length larger than two thirds of a length of the first edge.

12. The screen protector device of claim 1, further comprising:
a second protective film, comprising a third surface detachably attached to the outer surface; and
multiple positioning parts, each of which attached to the second protective film, and each of the multiple positioning parts comprising a protruding part outside the boundary of the transparent sheet, an adhesive area attached to the protruding part, and a strippable sheet detachably attached to the adhesive area;
wherein the multiple positioning parts, the auxiliary strip, and the first edge are of the same side of the screen protector device.

13. The screen protector device of claim 12, wherein a total length of the multiple positioning parts is larger than two thirds of a length of the first edge.

14. The screen protector device of claim 1, further comprising:
a second protective film, comprising a third surface detachably attached to the outer surface, the third surface comprising multiple extended areas outside the boundary of the transparent sheet;
multiple positioning parts, each of which comprising an adhesive area attached to one of the multiple extended areas, and a strippable sheet detachably attached to the adhesive area;
wherein the multiple positioning parts, the auxiliary strip, and the first edge are of the same side of the screen protector device.

15. The screen protector device of claim 14, wherein a total length of the multiple positioning parts is larger than two thirds of a length of the first edge.

16. A screen protector device, comprising:
a transparent sheet, comprising an inner surface, an outer surface, a first edge, and a second edge perpendicular to the first edge;
a first protective film, comprising a first surface and a second surface;
a second protective film, comprising a third surface detachably attached to the outer surface;
an auxiliary strip, positioned on the second surface of the first protective film, having a hardness greater than a hardness of the first protective film; and
multiple positioning parts, each of which attached to the second protective film, and each of the multiple positioning parts comprising a protruding part outside the boundary of the transparent sheet, an adhesive area attached to the protruding part, and a strippable sheet detachably attached to the adhesive area;
wherein the first surface is detachably attached to the inner surface;
wherein the auxiliary strip is positioned within the boundary of the transparent sheet, and a gap between the auxiliary strip and the first edge is less than 1 cm;
wherein the auxiliary strip has a length larger than four fifths of a length of the first edge, and has a width larger than 0.5 cm and smaller than one fifteenth of a length of the second edge;
wherein a total length of the multiple positioning parts is larger than two thirds of the length of the first edge;
wherein the multiple positioning parts, the auxiliary strip, and the first edge are of a same side of the screen protector device.
